(19) United States
(12) Patent Application Publication
(10) Pub. No.: US 2025/0384674 A1
(43) Pub. Date: Dec. 18, 2025

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Tatsuya TANAKA, Ichikawa (JP); Satoshi ITO, Kawasaki (JP)

(73) Assignee: KABUSHIKI KAISHA TOSHIBA, Tokyo (JP)

(21) Appl. No.: 19/047,003

(22) Filed: Feb. 6, 2025

(30) Foreign Application Priority Data
Jun. 18, 2024 (JP) 2024-097882

(51) Int. Cl. G06V 10/776; B25J 9/16; G06V 10/25; G06V 10/74; G06V 10/764; G06V 10/94; G06V 20/50

(52) U.S. Cl. CPC G06V 10/776; B25J 9/1679; G06V 10/25; G06V 10/761; G06V 10/764; G06V 10/945; G06V 10/955; G06V 20/50

(57) ABSTRACT

An information processing device according to an embodiment includes a hardware processor connected to a memory. The processor extracts a first object region including an object from an image. The processor calculates an evaluation value used for evaluating validity of the first object region. The evaluation value is calculated based on a first evaluation criterion and a second evaluation criterion different from the first evaluation criterion.

### CROSS-REFERENCE TO RELATED APPLICATIONS

This application is based upon and claims the benefit of priority from Japanese Patent Application No. 2024-097882, filed on Jun. 18, 2024; the entire contents of which are incorporated herein by reference.

### FIELD

An embodiment described herein relates generally to an information processing device, an information processing method, and a computer program product.

### BACKGROUND

Labor saving is being promoted through automation of logistics. For example, there are systems that automate picking operations through the use of picking robots. Such picking robot systems use an image recognition technology and other technologies to recognize the positions of objects such as items in containers.

However, in a case of wrong recognition, there is a risk of the objects being destroyed due to undesired robot manipulations. Techniques are thus required that evaluate the validity of object regions extracted by the image recognition.

As described above, with the conventional techniques, it is difficult to more precisely evaluate the validity of the object regions extracted from images.

### BRIEF DESCRIPTION OF THE DRAWINGS

FIG. 1 is a diagram illustrating an exemplary functional configuration of an information processing device in an embodiment;

FIG. 2 is a diagram illustrating an exemplary functional configuration of an evaluation unit in the embodiment;

FIG. 3 is a diagram illustrating an example of the processing of an augmentation unit and an segmentation unit in the embodiment;

FIG. 4 is a diagram illustrating an example of the processing performed by a first evaluation section in the embodiment;

FIG. 5 is a diagram illustrating an example of the processing performed by a second evaluation section in the embodiment;

FIG. 6 is a flowchart illustrating an example of an information processing method in the embodiment;

FIG. 7 is a diagram illustrating an exemplary functional configuration of an evaluation unit in a modification of the embodiment;

FIG. 8 is a diagram illustrating an example of object information in the modification of the embodiment; and

FIG. 9 is a diagram illustrating an exemplary hardware configuration of the information processing device in the embodiment.

### DETAILED DESCRIPTION

An information processing device according to an embodiment includes a

hardware processor connected to a memory. The hardware processor is configured to extract a first object region including an object from an image. The hardware processor is configured to calculate an evaluation value used for evaluating validity of the first object region. The evaluation value is calculated based on a first evaluation criterion and a second evaluation criterion different from the first evaluation criterion.

The following describes an embodiment of an information processing device, an information processing method, and a computer program product in detail with reference to the accompanying drawings.

An exemplary functional configuration of the information processing device in the embodiment will be described.

### Exemplary Functional Configuration

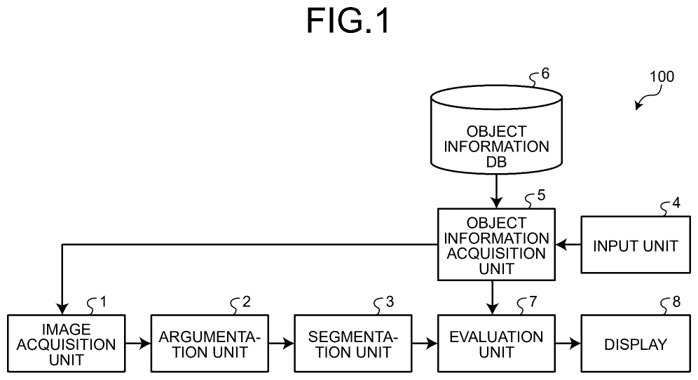

FIG. 1 is a diagram illustrating an exemplary functional configuration of an information processing device 100 in the embodiment. The information processing device 100 in the embodiment includes an image acquisition unit 1, an augmentation unit 2, an segmentation unit 3, an input unit 4, an object information acquisition unit 5, an object information DB 6, an evaluation unit 7, and a display 8.

The image acquisition unit 1 acquires one or more images including an object to be evaluated. In one example, the images are one or more captured images of the object to be evaluated. The object to be evaluated may be optional. In the embodiment, an exemplary case is described where each object is an item.

The method of acquiring the captured images may be optional. In the embodiment, an exemplary case is described where the captured image is an RGB image. Examples of the captured image may include a depth image, point cloud data (PCD), and an image captured by various sensors (such as an infrared camera) in addition to the RGB image.

Specifically, for example, the image acquisition unit 1 acquires an image capturing the item to be evaluated from an image database containing the captured images. The image acquisition unit 1 may take the image by using a camera system that captures the image of the item to be evaluated.

The augmentation unit 2 performs data augmentation processing on each captured image acquired by the image acquisition unit 1 to generate data augmentation images. The data augmentation processing can be any processing that performs predetermined transformation processing. The data augmentation processing includes at least one of the followings in the predefined transformation processing: horizontal flip, vertical flip, rotation, scaling, noise addition, padding, geometric transformation, and color transformation. The noise addition processing may be processing of addition, to an image, noise that degrades the quality of the image.

The segmentation unit 3 extracts an object region (a first object region) that indicates the object (in the embodiment, the item) from the captured image. The segmentation unit 3 extracts another object region (a second object region) that indicates the object (in the embodiment, the item) from each data augmentation image generated by the augmentation unit 2.

The method of extracting the object regions by the segmentation unit 3 may be optional. The segmentation unit 3 extracts the object regions by instance segmentation techniques such as Mask R-CNN (Mask Region-based Convolutional Neural Network).

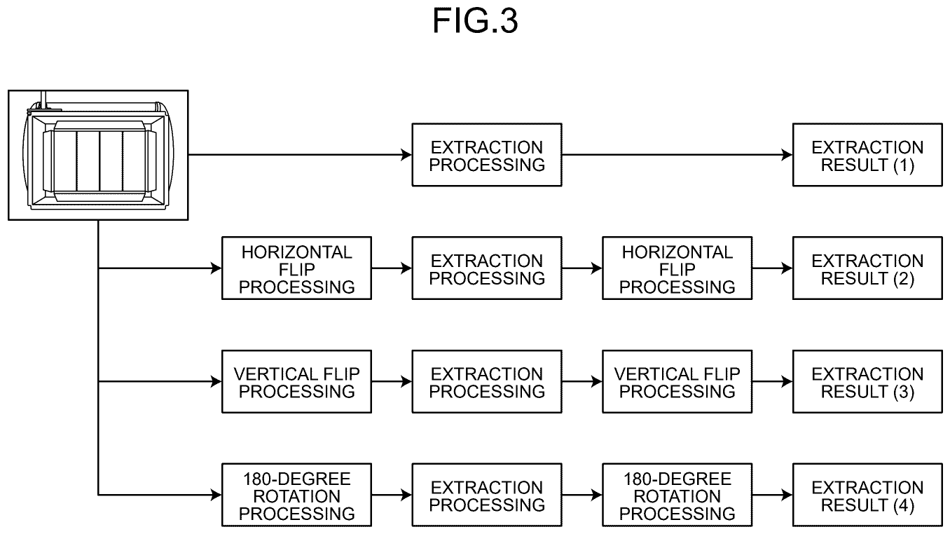

The details of the processing performed by the augmentation unit 2 and segmentation unit 3 will be described later with reference to FIG. 3.

The input unit 4 is a user interface (UI) serving to receive input information representing the object to be evaluated. The configuration of the input unit 4 may be optional. The input unit 4 is the UI such as a keyboard, a mouse, etc. The input unit 4 may be an interface serving to read item data saved in a predetermined format such as a file format of comma-separated value (CSV).

The object information acquisition unit 5 acquires object information (in the embodiment, item information) about the object to be evaluated (in the embodiment, the item). The object information includes at least one of identification information identifying the object, a size of the object, a shape of the object, the number of objects, and a texture of the object.

The identification information for identifying the object is, for example, an ID of the object. The size of the object is represented by the external dimensions of the object and the volume of the object. The texture of the object is the package image of the item when the object is the item.

The object information may further include the mass of the object and computer aided design (CAD) data (three-dimensional shape data) of the object.

The object information acquisition unit 5 may acquire the input information including the object information from the input unit 4. The object information acquisition unit 5 may acquire the object information already registered in the object information DB 6 in accordance with the input information from the input unit 4.

The object information DB (in the embodiment, item information DB) 6 is a database that stores the object information (in the embodiment, the item information). The object information DB 6 may be stored in a storage device such as a hard disk drive (HDD) of the information processing device 100, or in a data server device connected the information processing device 100.

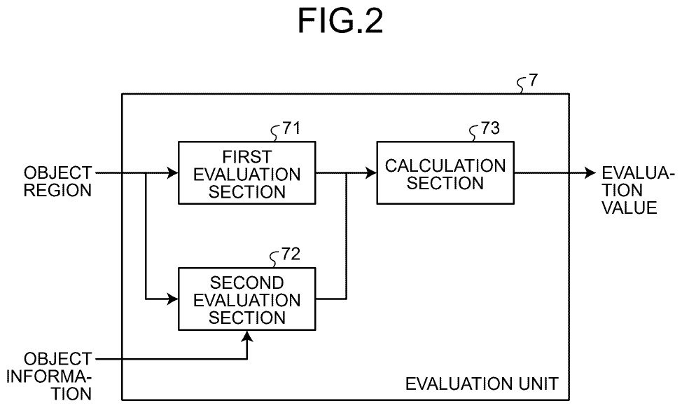

The evaluation unit 7 calculates an evaluation value for evaluating the validity of the object region based on the object regions extracted by the segmentation unit 3 and the object information obtained by the object information acquisition unit 5. The details of the processing performed by the evaluation unit 7 will be described later with reference to FIG. 2.

The display 8 displays evaluation information based on the evaluation value output from the evaluation unit 7. The configuration of the display 8 may be optional. The display 8 is a display monitor, which displays the display information including the object region to be evaluated and the evaluation information based on the evaluation value of the object region. The method of displaying the display information may be optional. The display 8 may display the evaluation value as it is as the evaluation information. The display 8 may also display the display information including the evaluation information based on the evaluation value (e.g., character information representing whether the evaluation result is valid).

The object to be evaluated is explicitly designated by the input unit 4 described above, and the display 8 displays the evaluation result of the designated object. This allows the change of later stage processing in accordance with whether the evaluation result is valid. In a picking robot system for picking objects, when there is a high risk of an error in the result of object region extraction (e.g., when the evaluation value is equal to or below a threshold value), a countermeasure can be taken, such as a person carries out the processing instead of a robot.

FIG. 2 is a diagram illustrating an exemplary functional configuration of the evaluation unit 7 in the embodiment. The evaluation unit 7 in the embodiment includes a first evaluation section 71, a second evaluation section 72, and a calculation section 73.

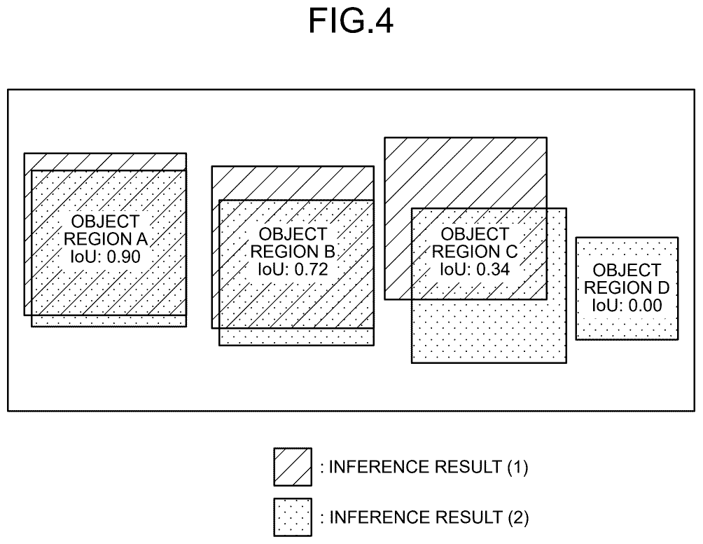

The first evaluation section 71 calculates the evaluation value for evaluating the validity of the object region based on a first evaluation criteria. Specifically, the first evaluation section 71 calculates a first evaluation value based on the object regions extracted by the segmentation unit 3. The details of the processing performed by the first evaluation section 71 will be described later with reference to FIGS. 3 and 4.

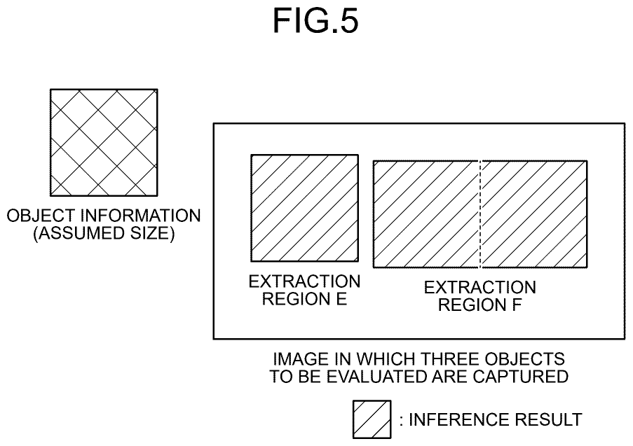

The second evaluation section 72 calculates the evaluation value for evaluating the validity of the object region based on a second evaluation criterion that is different from the first evaluation criterion. Specifically, the second evaluation section 72 calculates a second evaluation value based on the object information acquired by the object information acquisition unit 5. The details of the processing performed by the second evaluation section 72 will be described later with reference to FIG. 5.

The calculation section 73 calculates the evaluation value based on the first and second evaluations. The method of calculating the evaluation value based on the first and second evaluations may be optional. The calculation section 73 calculates the evaluation value by obtaining a weighted addition value, an average, a minimum, or a maximum value from the first and second evaluation values.

FIG. 3 is a diagram illustrating an example of the processing of the augmentation unit 2 and the segmentation unit 3 in the embodiment. In the example illustrated in FIG. 3, the augmentation unit 2 performs the data augmentation processing, which are the horizontal flip processing, the vertical flip processing, and the 180-degree rotation processing, on the captured image to obtain three data augmentation images. The example illustrated in FIG. 3 is a case where the data augmentation processing is performed on the captured image of a container containing four objects (e.g., items) each having a rectangular top surface, the image being captured from the top.

The segmentation unit 3 extracts the object region for each of the captured image and the three data augmentation images. The segmentation unit 3 performs the data augmentation processing on the three data augmentation images after extracting the object regions to restore the image position and orientation, etc., to the state of the original captured image. In the example illustrated in FIG. 3, four extraction results (1) to (4) are obtained from one captured image.

The type of data augmentation processing (the number of data augmentation images) may be optional. The segmentation unit 3 may also extract the object region from the data augmentation image without extracting the object region from the captured image. In the example illustrated in FIG. 3, the segmentation unit 3 may extract extraction results (2) to (4) from each of the three data augmentation images.

When the extraction processing performed by the segmentation unit 3 is robust also to the data augmentation image after the data augmentation processing, i.e., when the object region extraction results are consistent, it can be considered that the valid object region extraction is performed on the captured image.

Based on this idea, the first evaluation section 71 uses, as the first evaluation criteria, the degree of matching between the object region extracted from the captured image (the first object region) and the object region extracted from at least one data augmentation image (the second object region). The larger the degree of matching is, the higher the evaluation value of the first object region calculated by the first evaluation section 71 is.

Specifically, in the example illustrated in FIG. 3, the first evaluation section 71 performs the evaluation based on the degree of matching among the extraction results (1) to (4). The first evaluation section 71 calculates image features from each of the extraction results (1) to (4), and calculates the degree of matching based on the similarity in image feature among the extraction results (1) to (4). Specifically, the first evaluation section 71 may calculate the degree of matching in feature quantity by using cosine similarity. The explanation has been made with an example in which the cosine similarity is used as an evaluation index for the similarity in image feature. Other evaluation indexes, such as the distance between image features, may be used.

The first evaluation section 71 may calculate the degree of matching based on the overlap ratio among the extraction results (1) to (4) (masks of the object regions).

FIG. 4 is a diagram illustrating an example of the processing performed by the first evaluation section 71 in the embodiment. FIG. 4 illustrates an example of calculating the degree of matching based on the overlap ratios. Specifically, FIG. 4 illustrates the example of evaluating the degree of matching between the extraction results (1) and (2). The first evaluation section 71 maps object regions A to D obtained in the extraction results (1) and (2), and calculates their overlap ratios. The overlap ratio is an Intersection over Union (IoU) value. The first evaluation section 71 takes, as the degree of matching, the average value of the IoU values calculated for each of the object regions A to D. Examples of the statistic on the IoU values obtained from each of the object regions A to D may include a mode, a maximum, a minimum, and a median.

The explanation has been made with an example in which the IoU value is used as the evaluation index for the overlap ratio. Other evaluation indexes may be used.

The first evaluation section 71 calculates the degree of matching for each of the combinations of the extraction results (1) to (4) (₄C₂=6 ways). The average value of the degrees of matching is used as the evaluation value. Examples of the statistic on the degrees of matching obtained from each combination may include a mode, a maximum, a minimum, and a median.

The combinations to calculate the degrees of matching may be three ways, i.e., combinations between the extraction result (1) and each of the extraction results (2) to (4). The statistic may be calculated on the degrees of matching based on the three ways.

FIG. 5 is a diagram illustrating an example of the processing performed by the second evaluation section 72 in the embodiment. With reference to the example illustrated in FIG. 5, the following describes the extraction result of the object regions obtained from an image containing three objects to be evaluated (in the embodiment, items), and the evaluation of the object regions. The extraction result illustrates extraction regions E and F. The extraction region E is an example of the region being correctly extracted. On the other hand, the extraction region F is an example of two items arranged side by side being mistakenly extracted as a single item.

The second evaluation section 72 uses, as the second evaluation criterion, the similarity between the feature of the object indicated by the object region (the first object region) extracted from the captured image, and the object information representing the feature of the object. The larger the similarity between the feature of the object indicated by the first object region and the feature of the object indicated by the object information is, the higher the evaluation value of the first object region calculated by the second evaluation section 72 is.

Specifically, in the example illustrated in FIG. 5, the second evaluation section 72 calculates an assumed size of the item on the image based on the object information (e.g., shape information such as external dimensions of the item), and evaluates the validity of the extraction regions E and F. When the assumed size is that illustrated in FIG. 5, the extraction region E is evaluated as being valid. On the other hand, the extraction region F is evaluated as being anomalous because its size is larger than the assumed size.

The second evaluation section 72 compares the assumed size with the area of each of the extraction regions E and F. The larger the difference in area is, the lower the calculated evaluation value is. In other words, the smaller the difference in area is, the higher the evaluation value calculated by the second evaluation section 72 is. Alternatively, the second evaluation section 72 may calculate the evaluation value based on the ratio of the assumed size to the area of each of the extraction regions E and F, or based on the assumed size and the aspect ratio, which is the ratio of the height to the width, of each of the extraction regions E and F.

When the extraction results (1) to (4) are similarly wrong as in the case of the extraction region F in FIG. 5, the first evaluation section 71 cannot detect that the extraction region Fis anomalous. The evaluation value, however, can be correctly calculated by evaluating the extraction region based on the object information as described with reference to FIG. 5.

The assumed size may be calculated from the external dimensions by using a transformation table or other methods. The transformation table converts the external dimensions into the size on the image (how they look on the image). The assumed size may be calculated from an ID that identifies the object by using the transformation table in which the ID and the assumed size are correlated with each other.

In the example, the assumed size is used as the object information. The object information is not limited to the assumed size. The number of objects may be used as the object information. In this case, the second evaluation section 72 evaluates the extraction result by comparing the number specified by the object information with the number of extraction regions extracted from the image. When the object is the item, an image of the item package may be used as the object information. In this case, the second evaluation section 72 compares the similarity between the package image registered as the object information with the extraction region extracted from the image, and evaluates the extraction result based on the similarity.

### Example of Information Processing Method

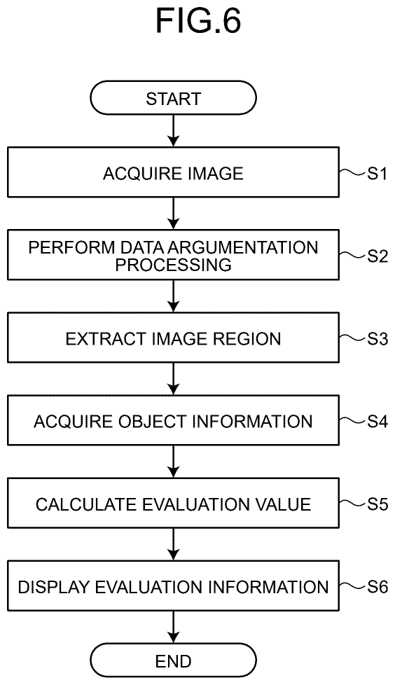

FIG. 6 is a flowchart illustrating an example of the information processing method in the embodiment. The image acquisition unit 1 acquires one or more images that include an object to be evaluated (in the embodiment, the item) (step S1).

The augmentation unit 2 performs the data augmentation processing including at least one piece of predetermined transformation processing on the image acquired at step S1 to generate at least one data augmentation image (step S2).

The segmentation unit 3 extracts the image regions including the object (step S3). Specifically, the segmentation unit 3 extracts the object region (the first object region) that includes the object from the image acquired at step S1. The segmentation unit 3 extracts another object region (the second object region) that includes the object from each data augmentation image generated at step S2.

The object information acquisition unit 5 acquires the object information (in the embodiment, the item information) about the object to be evaluated (step S4).

The evaluation unit 7 calculates the evaluation value for evaluating the validity of the first object region based on the first evaluation criterion and the second evaluation criterion that is different from the first evaluation criterion (step S5). The first evaluation criterion is the degree of matching between the first object region and at least one second object region. The second evaluation criterion is the similarity between the feature of the object indicated by the first object region and the object information representing the feature of the object.

Finally, the display 8 displays the evaluation information based on the evaluation value calculated at step S5 (step S6).

As explained above, in the information processing device 100 in the embodiment, the segmentation unit 3 extracts the object region (the first object region) that includes the object from the image. The evaluation unit 7 calculates the evaluation value for evaluating the validity of the first object region based on the first evaluation criterion and the second evaluation criterion that is different from the first evaluation criterion.

This allows the information processing device 100 in the embodiment to more accurately evaluate the validity of the object region extracted from the image. Specifically, the evaluation value is calculated in accordance with two different evaluation criteria. This can expect the effect that the errors occurring when the evaluation is performed with a single evaluation criterion (one evaluation criterion) is corrected by the evaluation performed with the other evaluation criterion.

The information processing device 100 in the embodiment can be applied to the visual inspection of products at a factory or the like. When the object region is extracted in a state where the object to be processed is known (the object information is available), the validity of the extraction result can be more correctly evaluated.

The embodiment describes an example in which the evaluation value is calculated for a single image. The evaluation unit 7 may calculate the evaluation value based on two or more images. In this case, the evaluation unit 7 calculates multiple evaluation values from multiple images and then calculates the statistic of the multiple evaluation values. Examples of the statistic may include a mean, a mode, a maximum, a minimum, and a median. The statistic is calculated based on the evaluation values of the multiple images. This can expect the effect of obtaining a more stable evaluation result. This has the effect of increasing robustness against the case where errors on evaluation values are found in some images.

### Modification of Embodiment

The following describes a modification of the embodiment. In the description of the modification, explanations similar to those of the embodiment are omitted, and the differences from the embodiment will be described.

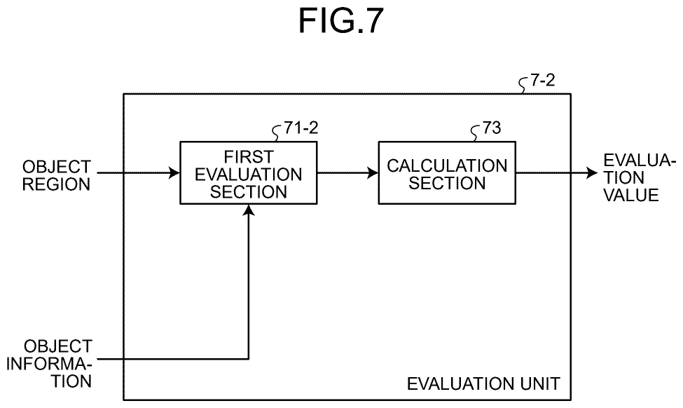

FIG. 7 is a diagram illustrating an exemplary functional configuration of an evaluation unit 7-2 in the modification of the embodiment. The evaluation unit 7-2 in the modification includes a first evaluation section 71-2 and the calculation section 73.

In the modification, the evaluation unit 7-2 identifies an internal region in which the object to be evaluated is stored based on the position information representing the internal region in which the object to be evaluated is stored. The second evaluation criterion is whether the first and second object regions are within the internal region in which the object to be evaluated is stored. The evaluation unit 7-2 calculates, only for the identified internal region, the evaluation value for evaluating the validity of the first object region.

Specifically, in the modification, the first evaluation section 71-2 calculates the evaluation value further based on the object information including the position information about the internal region in which the identified object (the object to be evaluated) is stored.

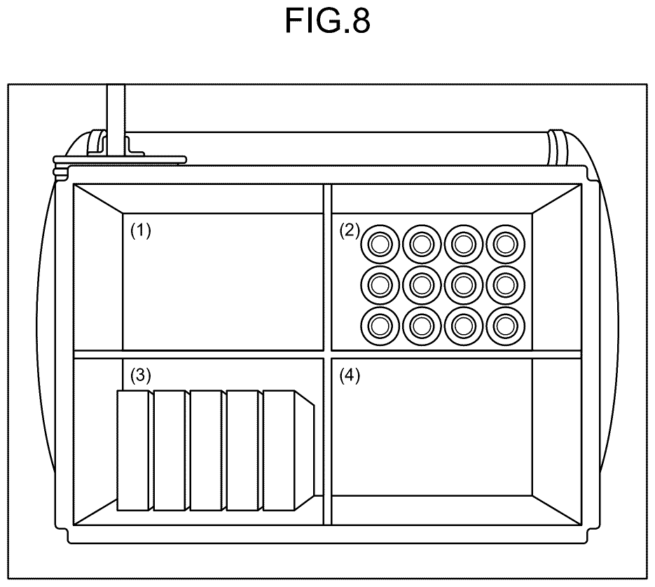

FIG. 8 is a diagram illustrating an example of the object information in the modification of the embodiment. FIG. 8 illustrates an example where a single container divided into multiple compartments in which different objects (e.g., items) are stored. In this example, a case will be described where whether a specific object (e.g., the object in the lower left compartment (3)) is correctly recognized.

The image in FIG. 8 also contains the objects (those in the compartments (1), (2), and (4)) other than the object to be evaluated. In such a case, conventionally, a problem arises in that the evaluation value of the object to be evaluated cannot be calculated correctly due to the influence of the objects in the compartments (1), (2), and (4).

In this example, the object information further includes compartment information regarding the container (e.g., a partitioning method and coordinates indicating the partitioning position), an object ID identifying the object, and the position information representing the position of the internal region in which the object identified by the object ID is stored.

The first evaluation section 71-2 calculates the evaluation value by considering only the compartment (3) in the evaluation value calculation described in the example illustrated in FIG. 4. This allows the evaluation value of a specific object to be calculated more correctly.

The compartment information regarding the container is not limited to the position information such as the coordinates. The compartment information may be given by a mask image that makes only the region to be evaluated effective.

As described above, in the modification, the objects are classified by the types of the objects and stored in multiple internal regions included in the container. The object information further includes the position information about each of the multiple internal regions. The evaluation unit 7-2 identifies the internal region in which the object to be evaluated is stored, from the position information, and calculates the evaluation value for evaluating the validity of the object region (the first object region) only for the identified internal region.

This modification makes it possible to focus on and evaluate only the specific item when multiple types of items are classified and stored in a container, for example.

The following describes an exemplary hardware configuration of the information processing device 100 in the embodiment.

### Example of Hardware Configuration

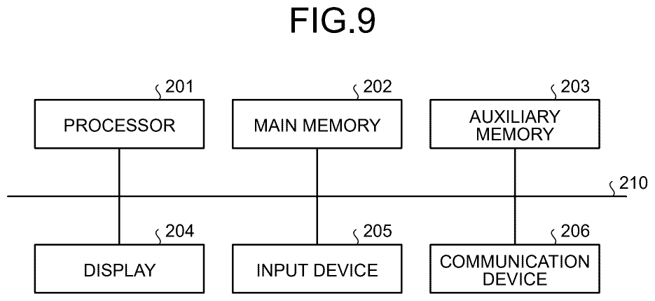

FIG. 9 is a diagram illustrating an exemplary hardware configuration of the information processing device 100 in the embodiment. The information processing device 100 in the embodiment includes a processor 201, a main memory 202, an auxiliary memory 203, a display 204, an input device 205, and a communication device 206. The processor 201, the main memory 202, the auxiliary memory 203, the display 204, the input device 205, and the communication device 206 are coupled via a bus 210.

The information processing device 100 does not necessarily include some of the components described above. When the information processing device 100 can use the input and display functions of an external device, the information processing device 100 does not necessarily include the display 204 and the input device 205.

The processor 201 executes a program read from the auxiliary memory 203 to the main memory 202. The main memory 202 is a read only memory (ROM) or a random access memory (RAM). The auxiliary memory 203 is a hard disk drive (HDD) or a memory card, for example.

The display 204 is a liquid crystal display, for example. The input device 205 is an interface for operating the information processing device 100. The display 204 and the input device 205 may be structured as a touch panel having both display and input functions, for example. The communication device 206 is an interface for communicating with other devices.

The program to be executed by the information processing device 100 is recorded in a computer-readable storage medium such as a memory card, a hard disk, a compact disc rewritable (CD-RW), a compact disc read only memory (CD-ROM), a compact disc recordable (CD-R), a digital versatile disc random access memory (DVD-RAM), and a digital versatile disc recordable (DVD-R), an installable or executable file, and provided as a computer program product, for example.

The program to be executed by the information processing device 100 may be stored in a computer coupled to a network such as the Internet and provided by being downloaded via the network, for example.

The program to be executed by the information processing device 100 may be provided via a network such as the Internet without being downloaded, for example. Specifically, the information processing may be performed via a service called an application service provider (ASP), which does not transfer the program from a server computer, but implements processing functions only through execution instructions and result acquisition.

The program to be executed by the information processing device 100 may be embedded and provided in a ROM, for example.

The program to be executed by the information processing device 100 has a module configuration that includes functions that can also be implemented by the program, in the functional configuration described above. In actual hardware, the processor 201 reads the program from the storage medium and executes the program, resulting in each of the function blocks being loaded onto the main memory 202. In other words, each of the function blocks is generated on the main memory 202.

Some of or all the functions described above may be implemented by hardware such as integrated circuits (ICs) without using software.

Each function may be implemented by using the multiple processors 201. In this case, each processor 201 may implement one of the functions or two or more of the functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising
a hardware processor connected to a memory and configured to:
extract a first object region including an object from an image; and
calculate an evaluation value used for evaluating validity of the first object region, the evaluation value being calculated based on a first evaluation criterion and a second evaluation criterion different from the first evaluation criterion.

2. The information processing device according to claim 1, wherein the hardware processor is configured to:
generate at least one data augmentation image by performing data augmentation processing including at least one piece of predetermined transformation processing on the image;
extract a second object region including the object from the at least one data augmentation image;
calculate, as the first evaluation criterion, a degree of matching between the first object region and the second object region; and
calculate the evaluation value of the first object region to become higher as the degree of matching is larger.

3. The information processing device according to claim 1, wherein
the second evaluation criterion is a degree of similarity between a feature of the object indicated by the first object region and object information representing a feature of the object, and
the hardware processor is configured to calculate the evaluation value of the first object region to become higher as the degree of similarity between the feature of the object indicated by the first object region and the feature of the object indicated by the object information is larger.

4. The information processing device according to claim 3, wherein the object information includes at least one of identification information identifying the object, a size of the object, a shape of the object, the number of objects, or a texture of the object.

5. The information processing device according to claim 3, wherein the hardware processor is configured to
receive, through a user interface, input information representing the object to be evaluated;
acquire the object information based on the input information; and
display, on a display device, evaluation information based on the evaluation value.

6. The information processing device according to claim 2, wherein
the objects are classified by types of the objects and stored in internal regions included in a container,
the hardware processor is configured to identify an internal region in which the object to be evaluated is stored, based on position information representing the internal region in which the object to be evaluated is stored,
the second evaluation criterion is defined by whether the first object region and the second object region are within the internal region, and
the hardware processor is configured to calculate, only for the identified internal region, the evaluation value for evaluating the validity of the first object region.

7. The information processing device according to claim 1, wherein the hardware processor is configured to calculate the evaluation values from the images and calculate a statistic of the evaluation values.

8. The information processing device according to claim 1, wherein the object is picked by a picking robot.

9. An information processing method comprising:
extracting a first object region including an object from an image; and
calculating an evaluation value used for evaluating validity of the first object region, the evaluation value being calculated based on a first evaluation criterion and a second evaluation criterion different from the first evaluation criterion.

10. A computer program product comprising a non-transitory computer-readable recording medium on which a program executable by a computer is recorded, the program instructing the computer to:
extract a first object region including an object from an image; and
calculate an evaluation value used for evaluating validity of the first object region, the evaluation value being calculated based on a first evaluation criterion and a second evaluation criterion different from the first evaluation criterion.
